(19) United States
(12) Patent Application Publication
(10) Pub. No.: US 2025/0333039 A1
(43) Pub. Date: Oct. 30, 2025

(54) Noise Damping Fiber With Surface Grooves

(71) Applicant: KNORR-BREMSE Systeme fuer Nutzfahrzeuge GmbH, Muenchen (DE)

(72) Inventors: Richard SOMODI, Helvicia (HU); Miklos TANCZOS, Kecskemet (HU); Szabolcs SOVAGO, Kecskemet (HU)

(21) Appl. No.: 18/866,114

(22) PCT Filed: May 30, 2023
(86) PCT No.: PCT/EP2023/064363

§ 371 Date: Nov. 15, 2024

(30) Foreign Application Priority Data
Jun. 2, 2022 (EP) 22176879.9

(51) Int. Cl. B60T 17/00; B29C 48/00; B29C 48/05; B29K 101/12; B29L 31/00; G10K 11/162

(52) U.S. Cl. CPC B60T 17/008; B29C 48/022; B29C 48/05; G10K 11/162; B29K 2101/12; B29K 2995/0072; B29L 2031/731

(57) ABSTRACT

A noise damping fiber for a noise damper for compressed air systems, in particular for brake systems of utility vehicles, has surface grooves formed by surface treatment. A method for producing a noise damping fiber mesh, includes the steps of: forming thermoplastic fibers by a molding tool or an extruding tool; surface treating of the fibers by the molding tool, the extruding tool, or another tool configured to treat the surface of thermoplastic fibers; and knitting, braiding or weaving a plurality of the surfaced treated fibers into a noise damping fiber mesh.

### BACKGROUND AND SUMMARY

The present invention relates to a noise damping fiber for a noise damper for compressed air systems, in particular for brake systems of utility vehicles. Further, the present invention relates to a noise damping fiber mesh as well as to a noise damper. Further, the present invention relates to a method for producing a noise damping fiber mesh.

In practice, it is known that compressed air systems often release large amounts of compressed air into the environment within a very short time. This expansion process can produce considerable noise. In order to keep the noise emission at an acceptable level, noise dampers or silencers are often necessary for compressed air systems.

As more and more environmental regulations lead to ever greater noise damping requirements for compressed air systems, the known systems are no longer effective enough to achieve the required high noise damping and at the same time sufficiently eliminate the risk of clogging and icing or to be accommodated in a space-saving manner.

Thus, in order to increase the performance of the noise dampers, the passage of the compressed air in the noise damping material or noise reducing material can be increased.

This can be achieved, on the one hand, by using a larger noise damper housing for the noise damping material. However, this is often difficult to implement because there is often not enough space available. In utility vehicles, the available space is increasingly limited and larger noise dampers can hardly be accommodated.

On the other hand, the flow path for the compressed air in the noise damping material accommodated within the noise damper housing can be prolonged. This depends, inter alia, on the density and structure of the noise damping material.

From WO 2019/063350 A1, a noise damper is already known which optionally uses a noise damping material in the form a fiber or thread material in weave, crochet or mesh structure but also a granular structure. The shape, size, strength, porosity, etc. of the thread material is selected in such a way that, on the one hand, it impedes the compressed air flow little, but on the other hand, it dampens the sound efficiently, whereby the compressed air flow passes from the inlet duct to outlet openings in the housing. However, the use of the noise damping material is indicated as optional.

Furthermore, DE 10 2004 036 030 A1 discloses a fiber or thread for noise damping material, in particular for a noise damper in compressed air systems, made of thermoplastic material. The material has structure or profiling formed or impressed into its surface which increases the surface area, the fiber being processed into a braided or knitted hose section, the ends of which are welded in such a way that an approximately rectangular hose section is formed, which, rolled into a knitted roll, forms the noise damping material. However, the disclosed fibers have smooth surface.

It is therefore an object of the present invention to improve a noise damping fiber as mentioned above, in particular in that the surface roughness is increased.

This object is solved according to the present invention with a noise damping fiber according to the features of the independent claim(s). Correspondingly, a noise damping fiber for a noise damper for compressed air systems, in particular for brake systems of utility vehicles, with surface grooves (e.g. micro surface grooves, or microscopic surface grooves) formed by surface treatment, is provided.

The invention is based on the basic idea that increasing the surface roughness by surface grooves, formed by surface treatment, further increases the noise damping performance of fibers compared to fibers with a smooth or nearly smooth surface, since the passing air is further deflected and thus the noise is damped by the rougher surface. In other words, the passing air develops a noise with less energy due to microscopic grooves which influence the behaviour of the turbulences of the air passing by. This also has the advantage that density or arrangement of fibers of a noise damping material inside a noise damper does not have to be changed.

Furthermore, it can be provided that the surface of the fiber has fringes and/or burrs. After surface treatment, i.e. by roughening the surface of the fiber, fringes or burr is formed. If these are left on the fiber's surface, they form further obstacles for the propagating noise.

It is also preferable that the fiber is made of a thermoplastic. Possible thermoplastics may be polypropylene (PP), or polyethylene (PE), or polyamide (PA), or poly (ethylene terephthalate) (PET), or polyester. A thermoplastic becomes pliable or moldable at a certain elevated temperature and solidifies upon cooling. The polymer chains associate by intermolecular forces, which weaken rapidly with increased temperature, yielding a viscous liquid. In this state, thermoplastics may be reshaped and are typically used to produce parts by various polymer processing techniques such as injection molding, compression molding, calendering, and extrusion. Another unique feature is the weldability of thermoplastics.

It is further preferable that the surface roughness of the fiber is at least 10 μm, preferably the surface roughness is in the range of 10 μm to 40 μm±10%.

It is still further preferable that the surface roughness of the fiber is at least twice as high after said surface treatment compared to before said surface treatment.

Moreover, it is possible that the length of the fringes and/or burr of the fiber is in the range of 0,05 to 10 mm, in particular in the range of 0,05 mm±10% to 10 mm±10%, preferably in the range of 0,05 mm±5% to 10 mm±5%.

Additionally or alternatively, it is also preferable that the length of the fringes and/or burr of the fiber is at least 0,05 mm.

Furthermore, it can be provided that the cross section of the fiber is rectangular, elliptical or circular.

The object of the present invention can further be solved by a noise damping fiber mesh which is knitted, braided or woven of a plurality of noise damping fibers as described above.

The object of the present invention can further be solved by a noise damper for compressed air systems, in particular for brake systems of utility vehicles, having a noise damping fiber mesh as described before.

Furthermore, the present invention relates to a method for producing a noise damping fiber mesh, wherein the method comprises the steps of:
forming thermoplastic fibers by a molding tool or an extruding tool;
surface treating of the fibers by the molding tool, the extruding tool, or another tool configured to treat the surface of thermoplastic fibers; and
knitting, braiding or weavening a plurality of the surfaced treated fibers to a noise damping fiber mesh.

Molding or extruding are well-known manufacturing processes for thermoplastics, which is why they should be preferably applied in case of the present starting or feedstock material. The surface treatment of the molded or extruded thermoplastic fibers can be applied during molding/extruding or even afterwards in an individual post-finishing step, wherein the surface treatment of the fibers can be performed in the molding or extruding tool, or in another, separate tool which is preferably located downstream with respect to the production line. Surface treatment should be understood as a roughening of the fibers' surface.

After the surface treatment, i.e. surface roughening, a defined plurality of surface roughened fibers is knitted, braded or woven together to form a noise damping fiber mesh, which is preferably used within a housing of a noise damper.

The shape of the mesh, the fiber pattern, density and thickness are matched to the desired application.

All of the structural and functional features associated with the noise damping fiber as well as its possible embodiments described above can, alone or in combination, also be provided in the method for producing a noise damping fiber mesh according to the present invention and the advantages associated therewith can be achieved as well.

Further details and advantages of the present invention shall now be disclosed in an embodiment according to the invention in connection with the drawings.

### BRIEF DESCRIPTION OF THE DRAWINGS

FIG. 1 is a schematic perspective view of a noise damping fiber of the prior art;

FIG. 2 is a top view of the noise damping fiber of FIG. 1;

FIG. 3 is a schematic perspective view of a first embodiment of a noise damping fiber according to the present invention;

FIG. 4 is a top view of a second embodiment of the noise damping fiber according to the present invention;

FIG. 5 is a top view of a third embodiment of the noise damping fiber according to the present invention;

FIG. 6 is an embodiment of a method for producing a noise damping fiber mesh according to the present invention;

FIG. 7 is a schematic perspective view of a fourth embodiment of a noise damping fiber according to the present invention; and

FIG. 8 is a schematic perspective view of a fifth embodiment of a noise damping fiber according to the present invention.

### DETAILED DESCRIPTION OF THE DRAWINGS

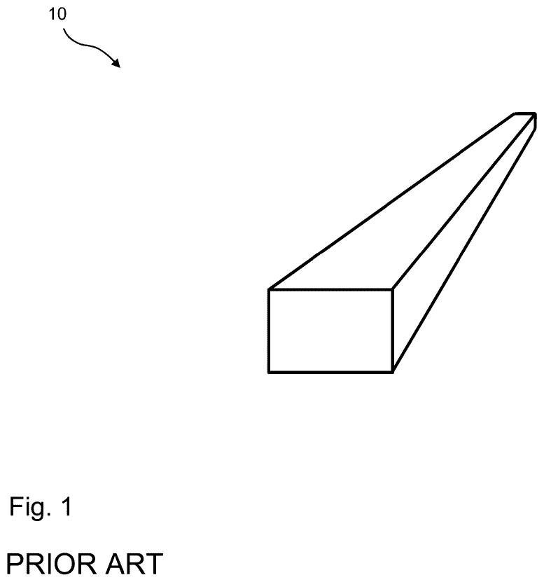

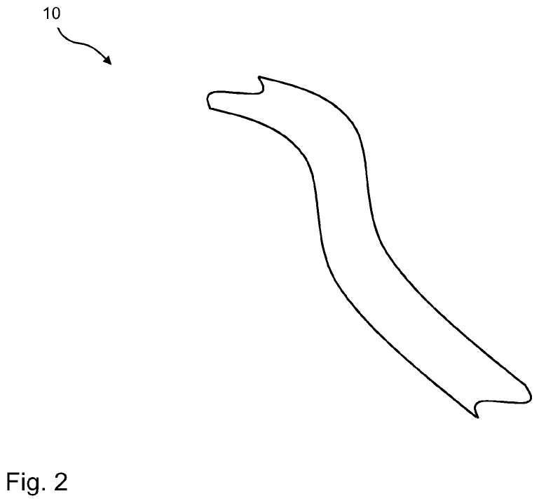

FIG. 1 shows a schematic perspective view of a noise damping fiber 10 of the prior art. The prior art fiber 10, made of a thermoplastic, has a smooth surface and a rectangular cross section. From FIG. 2 it can be understood that the fiber is flexible or bendable.

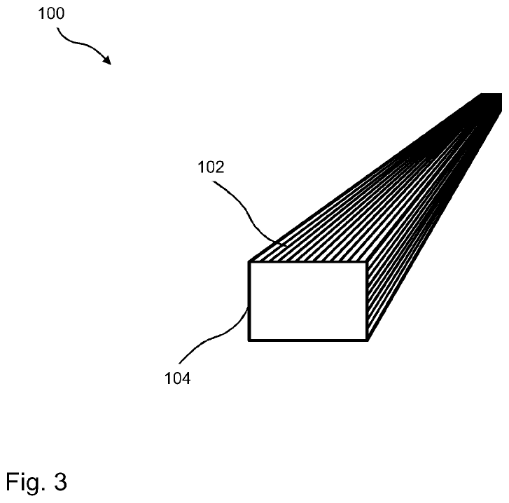

In FIG. 3, a schematic perspective view of a first embodiment of a noise damping fiber 100 according to the present invention is shown.

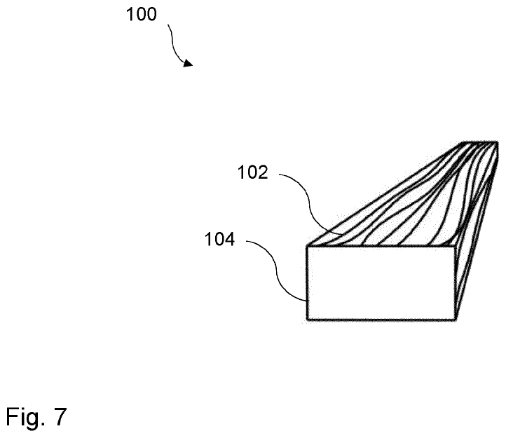

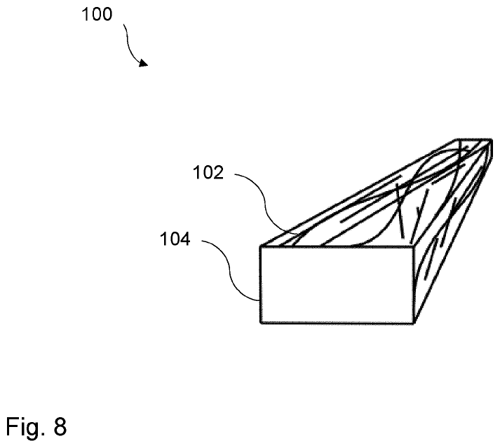

The fiber 100 has grooves 102, which are preferably lengthwise and continuous. The grooves 102 are arranged in a substantially parallel manner to each other. Other arrangements are also possible such as are shown in FIG. 7 and/or FIG. 8. The grooves are in the range of 10 to 40 μm, in particular in the range of at least 10 μm to 40 μm±10%.

The grooves 102 are inserted either after molding or extrusion or during molding or extrusion of the fiber.

The fiber 100 is made of a thermoplastic, which gives it flexibility or pliability.

The fiber 100 has a rectangular cross section 104. Other cross section shapes like a circle or ellipse are also possible.

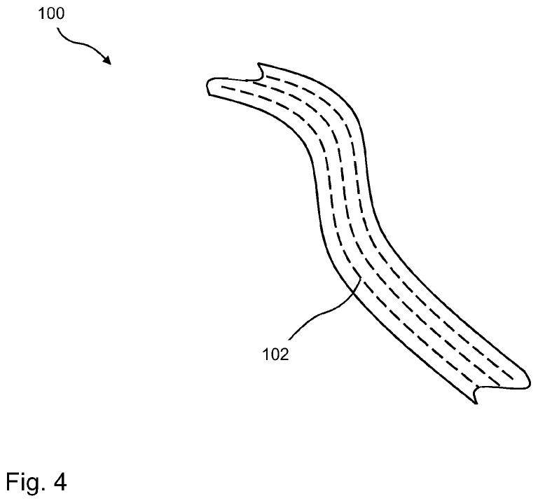

In FIG. 4, a top view of second embodiment of the noise damping fiber 100 is shown.

The fiber 100 of FIG. 4 has also lengthwise, but sectionally interrupted grooves 102.

The shape or design of grooves 102 depends on the surface treatment process and/or tool.

The grooves 102 can also run crosswise to the longitudinal extension of the fiber 100 or in any other direction.

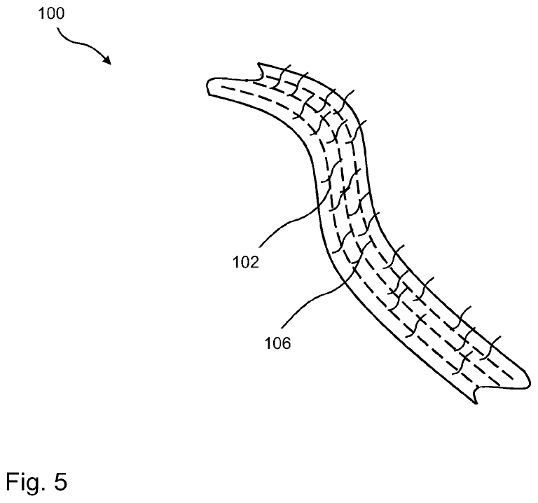

FIG. 5 shows a third embodiment of the noise damping fiber 100 according to the present invention.

The fiber 100 of FIG. 5 has, in addition to grooves 102, a plurality of fringes or burrs 106 which have not been removed after roughening the surface of the fiber 100.

Due to heterogeneous material composition, tolerances in fiber production and wear and tear on the surface treatment tools, the number, shape and distribution of the burrs 106 are non-uniform.

The burr 106 also prevents the noise from developing, just like the grooves 102.

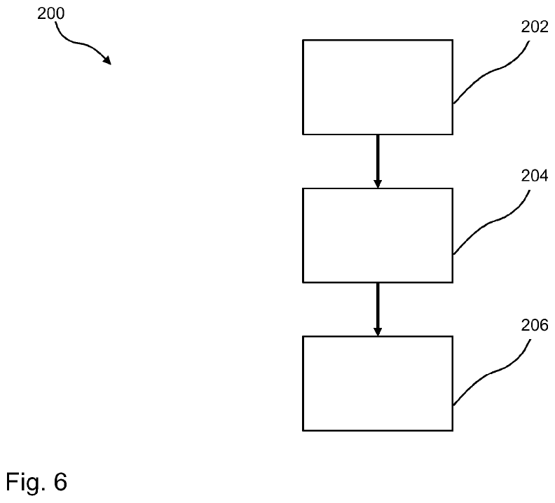

In FIG. 6, an embodiment of a method 200 for producing a noise damping fiber mesh is presented.

The method 200 is suitable to produce noise damping fibers 100 and noise damping fiber mesh according to the present invention.

In a first method step 202, thermoplastic fibers are formed by a molding or an extruding tool. In other words, a thermoplastic feedstock is formed into fibers.

In a second method step 204, the thermoplastic fibers' surface is treated either by the molding tool, the extruding tool, or another tool configured to treat the surface of thermoplastic fibers. Surface treatment is to be understood as the roughening of the surface, wherein roughening can be achieved by brushing, thorns, rolling or the like.

The method 200 thus provides the fibers 100 described above.

In a third method step 206, a plurality of the fibers 100 is knitted, braided or

woven to form a noise damping fiber mesh which may be used in a noise damper for compressed air systems.

When comparing results of surface roughness comparison measurements of fibers from different suppliers, it has been determined that the surface treatment leads to a significant increase in surface roughness R_{z}. The increase in surface roughness R_{z} leads to a better absorption of airborne sound or noise, i.e. sound energy is converted into dissipative energy. Thus, the noise absorption efficiency is increased by the larger or expanded surface area of the fibers.

In particular, said measurements were performed on fibers already knitted to fiber mesh. Accordingly, the respective raw material, i.e. as delivered, may have a lower surface roughness R_{z}, in particular compared to the material having been surface treated, e.g., roughened.

At least three measurements were carried out for each fiber type, wherein in addition to the values of the individual measurements, the average (avg.), minimum (min.) and maximum (max.) values in relation to the total of the at least three measurements of each fiber type were determined.

In this respect, it has been determined that a surface treatment according to the present invention results in a surface roughness of at least 10 μm. Furthermore, it appears that in particular the average surface roughness R_{z} after surface treatment is at least two times higher than that before the treatment.

In FIG. 7, a schematic perspective view of a fourth embodiment of a noise damping fiber 100 according to the present invention is shown.

The fiber 100 has grooves 102, which are preferably lengthwise and continuous. The grooves 102 are arranged in a substantially non-parallel manner to each other. The grooves are in the range of 10 to 40 μm, in particular in the range of at least 10 μm to 40 μm±10%.

The grooves 102 are inserted either after molding or extrusion or during molding or extrusion of the fiber.

The fiber 100 is made of a thermoplastic, which gives it flexibility or pliability.

The fiber 100 has a rectangular cross section 104. Other cross section shapes like a circle or ellipse are also conceivable.

In FIG. 8, a schematic perspective view of a fifth embodiment of a noise damping fiber 100 according to the present invention is shown.

The fiber 100 has grooves 102, which are substantially lengthwise and at least partly non-continuous. The grooves are in the range of 10 to 40 μm, in particular in the range of at least 10 μm to 40 μm±10%.

The grooves 102 are inserted either after molding or extrusion or during molding or extrusion of the fiber.

The fiber 100 is made of a thermoplastic, which gives it flexibility or pliability.

The fiber 100 has a rectangular cross section 104. Other cross section shapes like a circle or ellipse are also conceivable.

REFERENCE SIGNS

10 prior art noise damping fiber
100 noise damping fiber
102 grooves
104 cross section
106 fringe/burr
200 method for producing a noise damping fiber mesh
202 method step 1
204 method step 2
206 method step 3

1-12. (canceled)

13. A fiber for a noise damper of a compressed air system, comprising:
a noise damping fiber of the noise damper, wherein the noise damping fiber comprises surface grooves formed by surface treatment.

14. The fiber according to claim 13, wherein
a treated surface of the fiber has fringes and/or burrs.

15. The fiber according to claim 13, wherein
the fiber is made of a thermoplastic.

16. The fiber according to claim 13, wherein
a surface roughness of the fiber is at least 10 μm.

17. The fiber according to claim 16, wherein
the surface roughness of the fiber is in a range of 10 μm to 40 μm±10%.

18. The fiber according to claim 16, wherein
the surface roughness of the fiber is at least twice as high after said surface treatment compared to before said surface treatment.

19. The fiber according to claim 14, wherein
a length of the fringes and/or burrs of the fiber is at least 0.05 mm.

20. The fiber according to claim 19, wherein
the length of the fringes and/or burrs of the fiber is in the range of 0.05 to 10 mm.

21. The fiber according to claim 13, wherein
a cross section of the fiber is rectangular, elliptical or circular.

22. A fiber mesh, comprising:
a plurality of noise damping fibers knitted, braided or woven into the fiber mesh,
wherein the plurality of noise damping fibers have surface grooves formed by surface treatment.

23. The fiber mesh according to claim 22, wherein
a treated surface of the fiber has fringes and/or burrs.

24. The fiber mesh according to claim 22, wherein
the fiber is made of a thermoplastic.

25. The fiber mesh according to claim 22, wherein
a surface roughness of the fiber is in a range of 10 μm to 40 μm±10%.

26. A component for a compressed air system, comprising:
a fiber mesh according to claim 22; and
a noise damper comprising the fiber mesh.

27. A method for producing a noise damping fiber mesh, the method comprising the steps of:
forming thermoplastic fibers by a molding tool or an extruding tool;
surface treating the fibers by the molding tool, the extruding tool, or another tool configured to treat a surface of thermoplastic fibers; and
knitting, braiding or weaving a plurality of the surfaced treated fibers into the noise damping fiber mesh.

28. The method according to claim 27, wherein
the treated surface of the fiber has fringes and/or burrs.

29. The method according to claim 27, wherein
the fiber is made of a thermoplastic.

30. The method according to claim 27, wherein
a treated surface roughness of the fiber is in a range of 10 μm to 40 μm±10%.

31. The method according to claim 27, wherein
a treated surface roughness of the fiber is at least twice as high after said surface treatment compared to before said surface treatment.

32. The method according to claim 28, wherein
a length of the fringes and/or burrs of the fiber is in the range of 0.05 to 10 mm.
